(19) United States
(12) Patent Application Publication
(10) Pub. No.: US 2016/0227229 A1
(43) Pub. Date: Aug. 4, 2016

(54) MOBILE AD HOC NETWORK MEDIA AWARE NETWORKING ELEMENT

(71) Applicant: HARRIS CORPORATION, Melbourne, FL (US)

(72) Inventor: Michael A. Wadsworth, Palmyra, NY (US)

(21) Appl. No.: 14/613,762

(22) Filed: Feb. 4, 2015

(51) Int. Cl. H04N 19/30; H04N 19/146; H04L 12/18; H04N 19/40

(52) U.S. Cl. CPC H04N 19/30; H04N 19/40; H04N 19/146; H04L 12/189; H04W 84/18

(57) ABSTRACT

Systems (100) and methods (200) for controlling video stream distribution in an ad hoc network. A first network node (116 or 120) receives a first video stream (108) having a Scalable Video Codec format and a first Data Transfer Rate (“DTR”). The first network node resides between a video source device (102/106) and a video destination device (124, 128 or 132). The first network node then determines a second DTR for the first video stream based on conditions of communications links between the first network node and at least one second network node (118, 120, 126 or 130) downstream from the first network node. The first video stream is transferred from the first network node to the second network node at the second DTR which was previously determined, whereby any link quality impediments within the ad hoc network are resolved locally at the first network node.

### BACKGROUND

1. Statement of the Technical Field

The inventive arrangements relate to Mobile Ad Hoc Networks (“MANETs”). More particularly, the inventive arrangements concern MANET Media Aware Networking Elements (“MANEs”).

2. Description of the Related Art

Robust video distribution in a dynamic ad-hoc network is a difficult problem. Video encoding is typically performed at a fixed output rate. In this regard, a video codec is configured to supply a certain level of quality such that it generates more or less a consistent output in terms of bits per second. This may vary somewhat depending on the source content in the output signals. Generally, the variation is of a nominal rate. Since the output data transfer rate of the video codec is a fixed setting, a binary proposition is provided as to whether or not the communication infrastructure can support a video stream output from such a video codec. In the dynamic mobile ad hoc network, only some of the communication infrastructure may support the video stream at any given time. As such, the video stream may not arrive at all of its intended destination devices of the dynamic ad hoc network.

Various solutions have been derived to address this problem in dynamic mobile ad-hoc networks. One solution employs a closed loop control of the video source based on throughput conditions over the entire unicast route or multicast tree. In the closed loop control scenarios, a determination is made at a recipient device as to what kind of throughput is being seen thereat. After making such a determination, the recipient device sends a message to the video source indicating that the communication link therebetween cannot support the video signal output therefrom with the particular throughput or data transfer rate (e.g., 1 Mbps). In response to the reception of this message, the video source and recipient device negotiate a new date rate for the video stream to be sent from the video source. This process of correcting the data transfer rate of a downstream signal takes a relatively long period of time to complete. As such, this solution is problematic in dynamic unicast environments. For example, if there is a process that is changing at a faster rate than the ability to control the data transfer rates of the video streams output from a video source, then thrashing will occur in the network. Also, a least-common-denominator effect limits video quality in multicast situations (i.e., the network node with the worst throughput will control what the video source outputs for all network nodes).

### SUMMARY OF THE INVENTION

The invention concerns implementing systems and methods for controlling video stream distribution in an ad hoc network. The methods comprise receiving, by a first network node, a first video stream having a Scalable Video Codec (“SVC”) format and a first data transfer rate. The first network node resides between a video source device and a video destination device, and this constitutes an intermediary network node. Next, the first network node determines a second data transfer rate for the first video stream based on one-hop throughput conditions of a communications link between the first network node and a second network node downstream and one-hop away from the first network node, or based on multi-hop throughput conditions between further downstream network nodes in a communications path from the video source to an intended destination device. The first video stream is then transferred from the first network node to the second network node at the second data transfer rate which was previously determined. In effect, any link quality impediments within the ad hoc network are resolved locally at the first network node (rather than at the video source as is done in conventional ad hoc networks).

In some scenarios, the second data transfer rate is different than the first data transfer rate. If the second data transfer rate is lower than the first data transfer rate, then at least one enhancement layer may be pruned (or removed) from the composite first video stream prior to any transfer thereof to the second network node. The pruning of the enhancement layer from the first video stream may be based on a priority thereof and a priority of at least one other second video stream being transferred in the ad hoc network. The pruning may be performed to accommodate a reduced downstream data transfer rate. A reduced downstream data transfer rate may be caused by existing network traffic (e.g., network congestion) or may be caused by wireless propagation conditions.

Pruning may be affected by the congestion level of the ad hoc network, a current link quality, an estimate link quality as a function of time, and priority levels. Thus in those or other scenarios, a total number of enhancement layers for the first video stream is selected based on at least one of a congestion level of the ad hoc network, a current link quality, an estimate link quality as a function of time, and priority levels of at least two video streams. This selection may occur prior to any SVC encoding of the first video stream. Also, the total number of enhancement layers contained in the first video stream immediately after being SVC encoded may be different than that of a second video stream immediately after it has been SVC encoded.

At the source, the enhancement layer number and content is based on the network conditions. Network conditions vary with time and so the enhancement layer number and content for subsequent video streams may differ from the current video stream.

In those and yet other scenarios, a base layer of the first video stream is modulated onto a carrier signal using a first modulation scheme that is different than a second modulation scheme used to modulate an enhancement layer of the first video stream onto the carrier signal. Additionally or alternatively, different data transfer rates are used for at least a base layer and a first enhancement layer of the first video stream when a measured variance of a channel link quality or impulse response matrix over a given period of time reaches an undesirable level. A single data transfer rates may be used for at least a base layer and a first enhancement layer of the first video stream when a measured variance of a channel link quality or impulse response matrix over a given period of time is of a satisfactory level.

Notably, a network node involved in a unicast may choose to use differential modulation of the enhancement layers if warranted by channel condition variation with time. A network node involved in a multicast may choose to use differential modulation of the enhancement layers if warranted by channel condition variation in time and space. Therefore, in multi-cast scenarios, the above described process for controlling video stream distribution can be additionally employed when the measured variance of a channel link quality among a set of communication links originating from a source node exceeds a threshold value.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary architecture for a system that is useful for understanding the present invention.

FIGS. 2A-2D (collectively referred to herein as “FIG. 2”) is a flow diagram of an exemplary method for controlling video stream distribution in an ad hoc network.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present invention generally concerns systems and methods for controlling video stream distribution in a mobile ad hoc network. The video stream distribution is controlled locally based on local propagation conditions. Thus, any one of a plurality of intermediate network nodes (e.g., relay nodes) makes a decision as to what are the quality and propagation conditions of a communications link to a next hop device in a communications path (i.e., what throughput can that communications link sustain). Based on the results of this decision, the network node may send only a portion of a Scalable Video Codec (“SVC”) encoded video stream that will fit the capacities supported by the next hop node. In effect, the destination devices of the network do not have to negotiate with the video source for a new data transfer rate when a dynamic change occurs with regard to the quality and/or propagation conditions of the communications link established therebetween. Instead, any link quality impediments are resolved locally where they occur in the network.

Consequently, the present invention can handle quickly varying network conditions in a much more efficient and timely manner as compared to conventional closed loop control solutions (such as that discussed in the background section of this paper). Also, in the present case, the least-common-denominator effect does not limit video quality in multicast situations (i.e., the network node with the worst throughput will not control what the video source outputs for all network nodes). Accordingly, network nodes with high link quality routes to the video source will receive relatively high quality video, while network nodes with low link quality routes to the video source will receive relatively low quality video. The manner in which this video stream distribution is achieved will become evident as the discussion progresses. However, it should be understood that enhancement layers may be pruned from the SVC encoded video stream so as to reduce the quality and bit rate thereof. Enhancement layers will be discussed below.

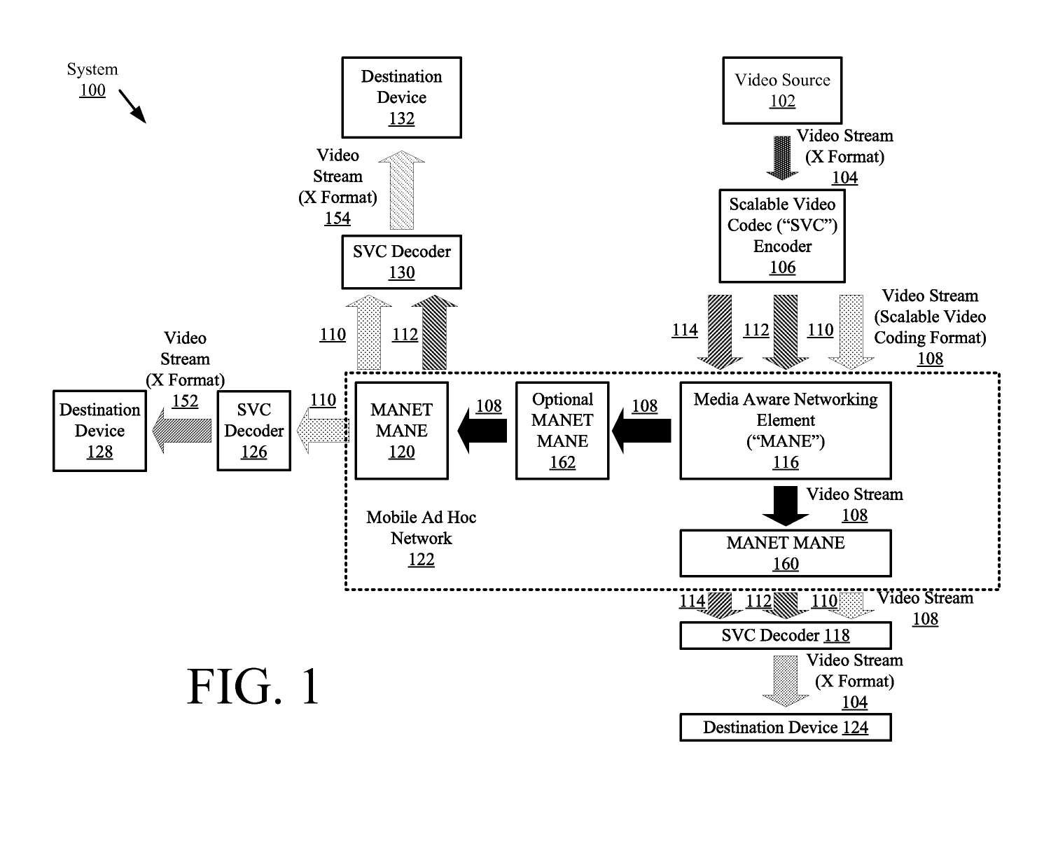

Referring now to FIG. 1, there is provided a schematic illustration of an exemplary architecture for a system 100 that is useful for understanding the present invention. System 100 is generally configured to control the distribution of data streams based at least on the contents of the data streams (e.g., audio and/or video). Thus, system 100 comprises a mobile ad hoc network 122 employing MANET MANEs 116, 120, 160, 162. The MANET MANEs 116, 120, 160, 162 employ a novel technique for handling video stream distribution. The novel techniques will become evident as the discussion progresses. Still, it should be understood that each MANET MANE 116, 120, 160, 162 is generally a network element capable of parsing network traffic (including, but not limited to, network-layer DCSP markings, Real-Time Transport Protocol (“RTP”) payload headers, and/or application payload) and reacting to the contents. The MANET MANE processing operates across multiple protocol layers of an OSI protocol stack. As should be understood, the protocol layers include an application layer, a transport layer, a network layer, a media access control layer, a data link layer, and a physical layer. Thus, the MANET MANE processing provides full cross-layer optimization and wireless cognizance.

During operation of system 100, a video source 102 generates a video stream 104 having a particular format X. The video source 102 can include, but is not limited to, a personal computer. Personal computers are well known in the art, and therefore will not be described herein. Format X can include, but is not limited to, an MPEG video format, an H.320 video format, and/or a Digital Video Disc (“DVD”) video format. Each of the listed types of video formats is well known in the art, and therefore will not be described herein. The video stream 104 is then sent to an SVC encoder 106.

At the SVC encoder 106, the video stream 104 is encoded in accordance with an SVC technology so as to form a video stream 108 having an SVC format. Scalable video encoding techniques are well known in the art, and therefore will not be described in detail herein. However, it should be understood that scalable video encoding generally involves encoding bits of a video stream (e.g., video stream 104) into bits-to-be-transported via a network (e.g., the mobile ad hoc network 122) in a compartmentalized fashion. In effect, the coded video stream output from SVC encoder 106 comprises a lower data transfer rate, lower quality video stream 108 with a base layer 110 and a plurality of enhancement layers 112, 114. Although only two enhancement layers are shown in FIG. 1, the present invention is not limited in this regard. Any number of enhancement layers may be employed herein in accordance with a particular application.

Notably, the layers 110-114 are carried as separate identifiable data streams through system 100. As such, each layer 110-114 can be sent through the system using the same or different modulation schemes. For example, the base layer 110 may be modulated on a first carrier signal using a more robust modulation technique than that used to modulate the enhancement layers 112, 114 onto a second carrier signal. In turn, the enhancement layer 112 may be modulated on a more robust modulation technique than the enhancement layer 114. This modulation technique provides analog-like video quality degradation, increased video range and receiver-driven broadcast performance for silent network participants.

Each layer 110-114 can also be sent through the system at the same or different data transfer rate. For example, in single data transfer rate mode scenarios, all of the layers 110-114 are sent at 400 kilobits per second. In multi data transfer rate scenarios, the base layer can be sent through the system 100 at 200 kilobits per second, while the enhancement layers 112, 114 are sent at 400 kilobits per second. In turn, enhancement layer 114 may alternatively be sent at 800 kilobits per second. In effect, at least the base layer of the video stream will still be delivered to the intended destination device when variations in channel quality unexpectedly occur. As such, a wider set of signal conditions is provided at which the video stream can travel through system 100 without being entirely lost or dropped due to rapidly varying channel conditions. The present invention is not limited to the particular data transfer rates used in this example.

Notably, system 100 can operate in either the single or multi data transfer rate mode at any given time. Trigger events can cause the system to operate in one of the particular data transfer rate modes and/or transition to another data transfer rate mode. Such trigger events can include, but are not limited to, the degree of variance of a channel link quality and/or an impulse response matrix over a given period of time.

In some scenarios, the total number of enhancement layers contained in a video stream is fixed. In other scenarios, the total number of enhancement layers contained in a video stream is advantageously variable based on congestion levels in system 100, a current link quality, an estimate link quality as a function of time, and/or priority levels of video stream relative to each other. The maximum number of enhancement layers (e.g., 4X) may be selected to provide at least a 10 dB range of variation in signal quality that the SVC coding of the SVC encoder 106 can produce. Such a maximum number would allow data transfer rates at least between 250 kilobits per second to 2.5 Megabits per second. Notably, in this case, a plurality of video streams generated by SVC encoder 106 may have different numbers of enhancement layers. For example, a high priority video stream comprises four enhancement layers, while a low priority video stream comprises one enhancement layer.

The aggregate of the base layer 110 and the enhancement layers 112, 114 creates a relatively high quality (potentially high definition) representation of the video stream 104. Each enhancement layer 112, 114 creates a higher level of video quality when applied to the base layer 110. Therefore, an SVC encoded video stream comprising two enhancement layers 112, 114 has a higher quality level as compared to an SVC encoded video stream comprising only one enhancement layer 112. Stated differently, the quality of the video stream improves with the addition of an enhancement layer, and degrades with the loss of an enhancement layer. Also, the addition of an enhancement layer increases the data transfer rate of the composite encoded video stream. In contrast, the removal of an enhancement layer decreases the data transfer rate of the composite encoded video stream.

The SVC encoded video stream 108 is then sent from the SVC encoder 106 to the source-side MANET MANE 116. In some scenarios, the video stream 108 may be encrypted prior to being communicated from the SVC encoder 106 to the MANET MANE 116. The MANET MANE 116 does not need to decrypt the video stream prior to processing the same for enhancement layer pruning purposes and/or routing purposes. This is at least partially a result from the fact that some of the video stream header fields (e.g., a Differential Service Code Point (“DSCP”) marking) bypass the encryption device, and are used by the MANET MANE 116 during its operations described below to identify the base layer 110 and each of the enhancement layers 112, 114.

At the source-side MANET MANE 116 (or another relaying MANE 160), a data transfer rate decision for the composite SVC encoded video stream is made based on the one-hop throughput conditions and/or further downstream throughput conditions, i.e., the quality and propagation metrics of a communications link between the MANET MANE 116 and the next network node 160 or 162 in a communications path from the video source 102 to at least one intended destination device 124 or 128/132. The quality of the communications link is determined based on the Signal to Noise Ratio (“SNR”), estimations of channel impulse responses, channel parameters, delay spread, and/or Doppler spread. For example, if the communications link between MANET MANE 116 and a next network node 160 or 162 can support a high throughput rate, then the MANET MANE 116 sends the entire SVC encoded video stream 108 to the next network node 160 or 162 without pruning any of the enhancement layers therefrom. In contrast, if the communications link between MANET MANE 116 and a next network node 160 or 162 can support an intermediary throughput rate and not a high throughput rate, then the MANET MANE 116 prunes at least one enhancement layer from the video stream and forwards the pruned video stream to the next network node 160 or 162. As a result of employing the one-hop throughput based technique, link quality impediments are resolved locally at the MANET MANE 116 based on wireless networking knowledge (relating to the media access layer, data link layer and/or physical layer). Notably, this is not the case in conventional CAN-based systems. The present invention is not limited to the particulars of this example. In some scenarios, pruning of the enhancement layer can be based alternatively or additionally in accordance with priority based congestion resolution (i.e., the priority of data of a first data stream is higher or lower than that contained in a second data stream). Additionally or alternatively, the MANET MANE 116 may prune at least one enhancement layer from the video stream and forward the pruned video stream to the MANET MANE 162 if the reported link quality between the MANET MANE 162 and the MANET MANE 120 supports an intermediary throughput rate and not a high throughput rate.

As shown in FIG. 1, the next network node of a first communication path comprises SVC decoder 160. Since the communications link between the MANET MANE 116 and the SVC decoder 160 can support a high throughput rate, the entire SVC encoded data stream 108 is sent thereto from MANET MANE 116. Similarly, the entire SVC encoded data stream 108 is sent from MANET MANE 160 to an SVC decoder 118.

As also shown in FIG. 1, the next network node of a second communication path comprises MANET MANE 120. Since the communications link between the MANET MANE 116 and the MANET MANE 120 can support a high throughput rate, the entire SVC encoded data stream 108 is sent thereto from MANET MANE 116. In effect, the MANET MANE 116 simply provides the same video stream to the MANET MANE 162 for multiple destination nodes 128, 132 without having to respectively create separate video streams therefore which have different data transfer rates. In turn, the entire SVC encoded data stream 108 is sent from MANET MANE 162 to a MANET MANE 120.

The present invention is not limited to the embodiment shown in FIG. 1. For example, video stream 108 may include additional components other than components 110-114. In this case, MANET MANE 162 may perform operations to prune the additional component(s) from the video stream 108 prior to forwarding the same to the MANET MANE 120.

This is significantly different than what is done in conventional MANET systems. In conventional unicast MANET systems, data transfer rate decisions are made by the video source 102/106 based on reported end-to-end throughput conditions (and do not include decision criteria based on MANET conditions such as wireless link quality and congestion), which may not be able to track dynamic wireless network conditions. In conventional multicast MANET systems, data transfer rate decisions are made by the video source based on lowest common denominator reported end-to-end throughput conditions.

As noted above, the entire SVC encoded video stream 108 is communicated to the SVC decoder 118 and the MANET MANE 120. The SVC decoder 118 decodes the SVC encoded video stream 108, and forwards the decoded video stream 104 to the destination device 124.

In some scenarios, the video stream 108 may be encrypted prior to being communicated to the MANET MANE 120. The MANET MANE 120 does not need to decrypt the video stream prior to processing the same for enhancement layer pruning purposes and/or routing purposes. This is at least partially a result from the fact that some of the RTP stream header fields (e.g., DSCP marking) bypass the encryption device, and are used by the MANET MANE 120 during its operations described below to identify the base layer 110 and each of the enhancement layers 112, 114.

The operations performed by the MANET MANE 120 involve making data transfer rate decisions for the composite SVC encoded video stream based on wireless local network conditions, i.e., the conditions of a communications link between the MANET MANE 120 and a next network node 126 or 130, or conditions further removed (i.e., the conditions between network nodes 126 and 120). For example, let's assume that the communications link (e.g., an Ethernet link) between the MANET MANE 120 and the SVC decoder 126 can only support the lowest level throughput or that the display abilities of the destination device 128 can only support the lowest level throughput or data transfer rate. In this case, the MANET MANE 120 processes the SVC encoded video signal 108 so as to remove all of the enhancement layers 112, 114 therefrom. In effect, only the base layer 110 of the video signal 108 is sent from the MANET MANE 120 to the SVC decoder 126. The SVC decoder 126 then decodes the base layer 110 and sends the decoded base layer 152 to the destination device 128. Let's also assume that the communications link between the MANET MANE 120 and the SVC decoder 130 can support the middle level throughput or that the display abilities of the destination device 132 can support the middle level throughput or data transfer rate. In this case, the MANET MANE 120 processes the SVC encoded video signal 108 so as to remove the enhancement layer 112 therefrom. Accordingly, the base layer 110 and the enhancement layer 112 are sent from the MANET MANE 120 to the SVC decoder 130. The SVC decoder 130 then decodes the base layer 110 and the enhancement layer 112, and sends the decoded video stream component 154 to the destination device 132. As a result of employing the one-hop throughput based technique, link quality impediments are resolved locally at the MANET MANE 120, and not at the video source 102/106 as is done in conventional CAN-based systems.

Notably, the system 100 provides graceful video quality degradation with network offered load. For example, in some scenarios, there may be multiple video streams in existence at a particular place in the system 100. Instead of not supporting one of the video streams in favor of another one of the video streams, the system 100 would support both video streams at any given time by pruning one or more enhancement layers therefrom. As mentioned above, the number of enhancement layers that are pruned from each video stream can be based on the relative priorities of the video streams. This is significantly different than what occurs in conventional CAN-based systems. In the conventional CAN-based systems, one of the video streams would be dropped based on its priority level as compared to that of the other video stream.

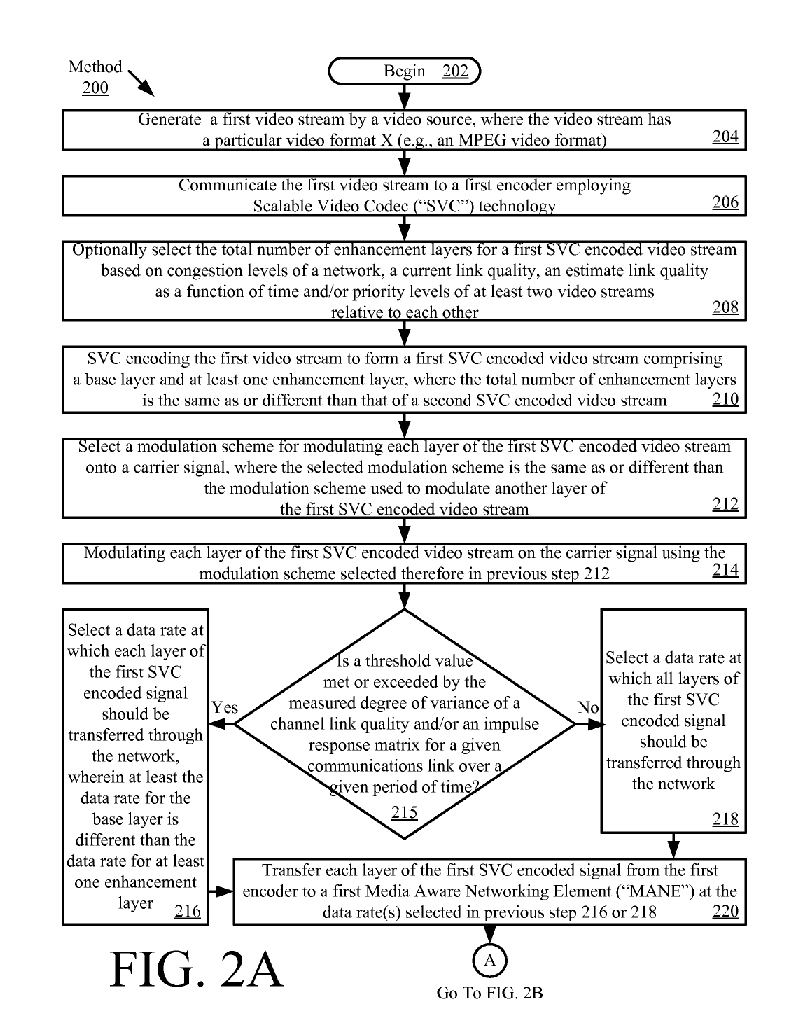

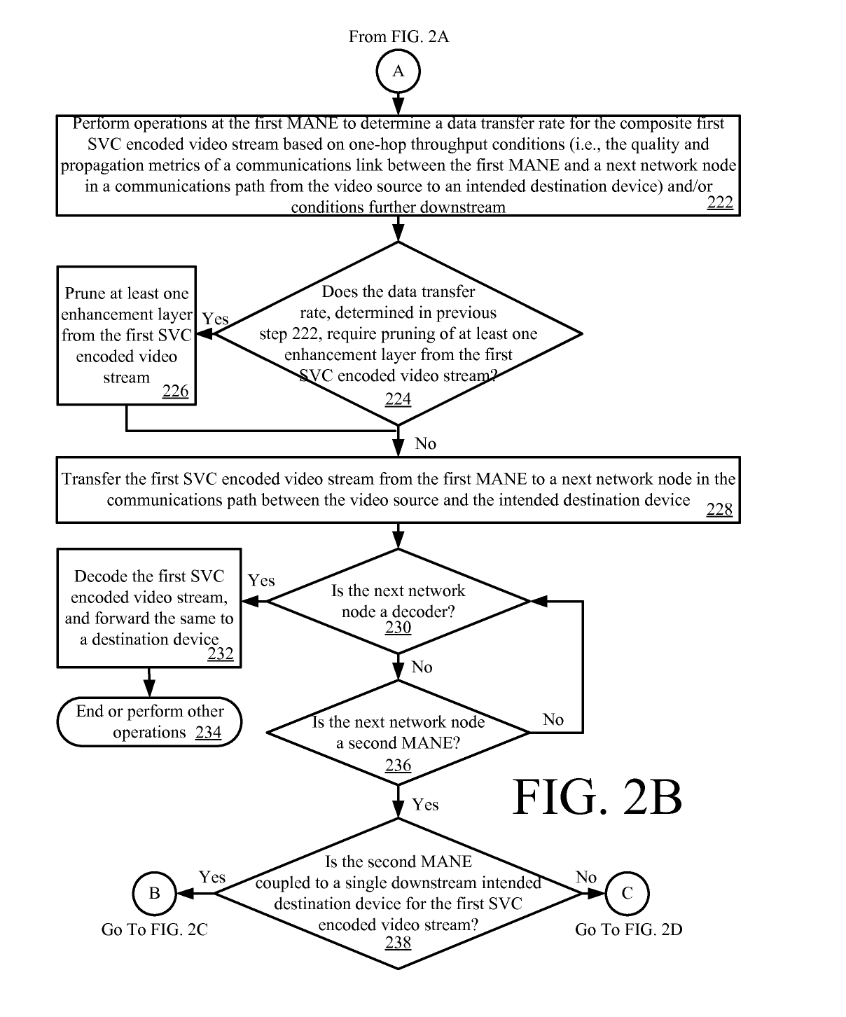

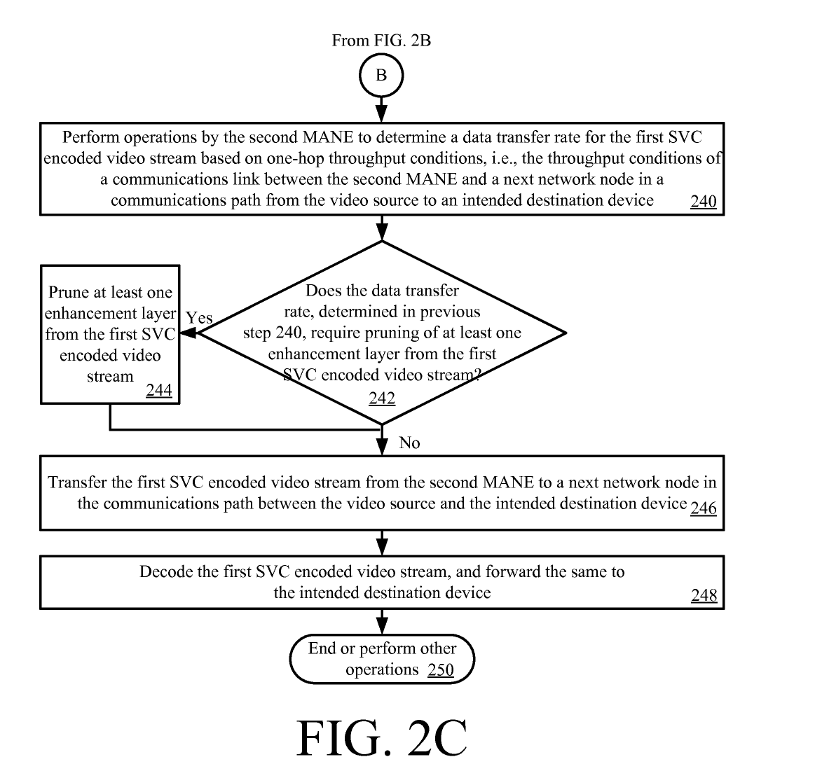

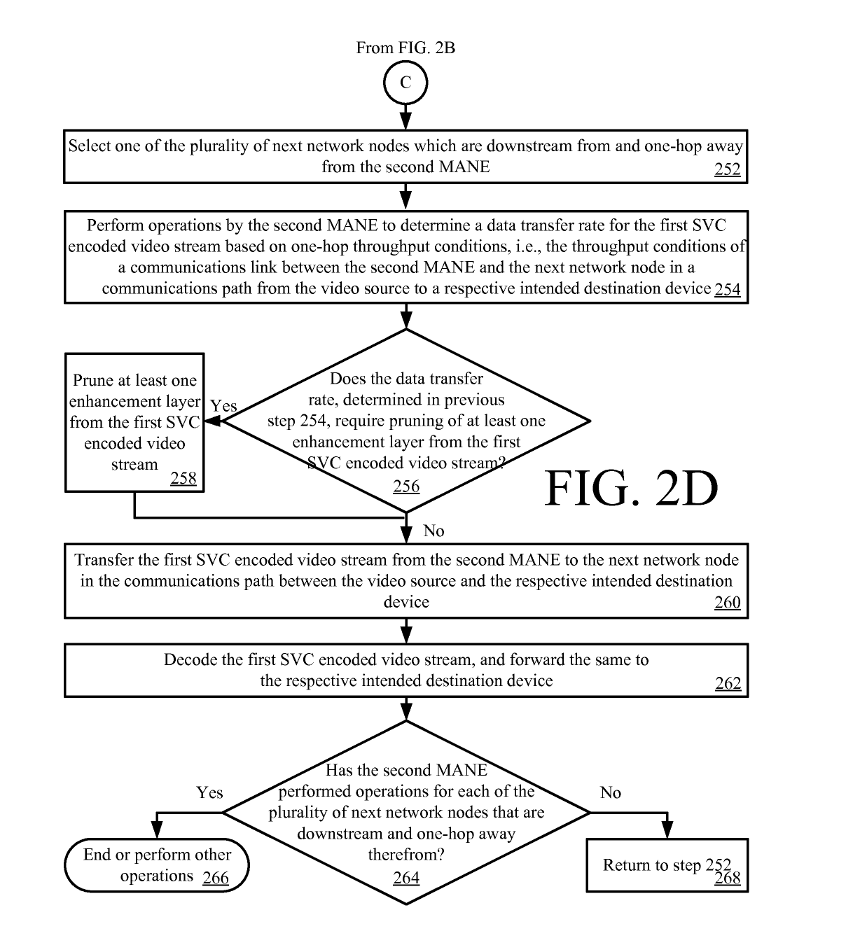

Referring now to FIG. 2, there is provided a flow diagram of an exemplary method 200 for controlling video stream distribution in an ad hoc network. Method 200 begins with step 202 and continues with step 204. In step 204, a first video stream (e.g., video stream 104 of FIG. 1) is generated by a video source (e.g., video source 102 of FIG. 1). The first video stream has a particular video format X. Video format X can include, but is not limited to, an MPEG video format, an H.320 video format, and/or a Digital Video Disc (“DVD”) video format. Each of the listed types of video formats is well known in the art, and therefore will not be described herein.

As shown by step 206, the first video stream is then communicated from the video source to a first encoder (e.g., SVC encoder 106 of FIG. 1). Notably the first encoder employs SVC technology. Thus, in a next optional step 208, a total number of enhancement layers for a first SVC encoded video stream is selected based on congestion levels of a network, a current link quality, an estimate link quality as a function of time, and/or priority levels of at least two video streams relative to each other.

The first SVC encoded video stream (e.g., video stream 108 of FIG. 1) is then generated in step 210 by SVC encoding the first video stream. The first SVC encoded video stream comprises a base layer (e.g., base layer 110 of FIG. 1) and at least one enhancement layer (e.g., enhancement layer 112 and/or 114 of FIG. 1). The total number of enhancement layers contained in the first SVC encoded video stream is the same as or different than that of a second SVC encoded video stream.

In step 212, a modulation scheme is selected for each layer of the first SVC encoded video stream. The selected modulation scheme may be the same as or different than the modulation scheme used to modulate another layer of the first SVC encoded video stream. After the modulation scheme(s) is(are) selected, each layer of the SVC encoded video stream is modulated onto the carrier signal in accordance with the modulation scheme previously selected therefore, as shown by step 214.

Upon completing step 214, method 200 continues with a decision step 215. Decision step 215 involves determining whether or not a threshold value is met or exceeded by a measured degree of variance of a channel link quality and/or an impulse response matrix for a given communications link over a given period of time and the expected path(s) of travel in the network. If the threshold value is met or exceeded [215:YES], then step 216 is performed where a data rate is selected for each layer of the first SVC encoded video stream. The selected data rate is the data transfer rate at which the respective layer should be transferred through the network. At least the data transfer rate for the base layer of the first SVC encoded video stream is different than the data transfer rate for at least one enhancement layer of the first SVC encoded video stream. For example, the data transfer rate selected for the base layer is lower than the data transfer rate for an enhancement layer. Upon completing step 216, step 220 is performed. Step 220 will be described below.

If the threshold value is not met or exceeded [215:NO], then step 218 is performed where a data rate is selected for all of the layers of the first SVC encoded video stream. The data rate comprises the data transfer rate at which all of the layers of the first SVC encoded video stream should be transferred through the network. Thereafter, step 220 is performed. In step 220, each layer of the first SVC encoded signal is transferred from the first encoder to a first MANE (e.g., MANET MANE 116 of FIG. 1) at the data rate(s) selected in previous step 216 or 218. Once step 220 is completed, method 200 continues to step 222 of FIG. 2B.

As shown in FIG. 2B, step 222 involves performing operations at the first MANE to determine a data transfer rate for the composite first SVC encoded video stream. This determination is based on one-hop throughput conditions (i.e., the quality and propagation metrics of a communications link between the first MANE and a next network node in a communications path from the video source to an intended destination device) and/or multi-hop throughput conditions further downstream (i.e., the quality and propagation metrics of a communications link between further downstream network nodes in a communications path for the video source to an intended destination device). After the data transfer rate has been determined, a decision step 224 is performed.

Decision step 224 involves determining whether or not the data transfer rate requires pruning of at least one enhancement layer from the first SVC encoded video stream. If the pruning is not required [224:], method 200 continues with step 228, which will be discussed below. In contrast, if the pruning is required [224:YES], step 226 is performed where at least one enhancement layer is pruned from the first SVC encoded video stream. Next in step 228, the first SVC encoded video stream is transferred from the first MANE to a next network node in the communications path between the video source and the intended destination device.

If the next network node is a decoder (e.g., SVC decoder 118 of FIG. 1) [230:YES], then step 232 is performed where the first SVC encoded video stream is decoded and forwarded to the respective destination device (e.g., destination device 124 of FIG. 1). Thereafter, the method 200 ends or other processing is performed as shown by step 234.

If the next network node is not a decoder but rather a second MANE (e.g., MANE 120 of FIG. 1) [236:NO] and [236:YES], then a decision is made in step 238 as to whether or not the second MANE is coupled to a single downstream intended destination device for the first SVC encoded video stream. If the second MANE is coupled to a single downstream intended destination device, method 200 continues with step 240 of FIG. 2C. In contrast, if the second MANE is coupled to more than one downstream intended destination device, method 200 continues with step 252 of FIG. 2D.

Referring now to FIG. 2C, step 240 involves performing operations by the second MANE to determine a data transfer rate of the first SVC encoded video stream. This determination is made based on one-hop throughput conditions (i.e., the throughput conditions of a communications link between the second MANE and a next network node in a communications path from the video source to an intended destination device). Once the data transfer rate has been determined, a decision is made in step 242 as to whether or not the data transfer rate requires pruning at least one enhancement layer from the first SVC encoded video stream. If pruning is required [242:YES], then at least one enhancement layer is pruned from the first SVC encoded video stream, as shown by step 244. Thereafter, step 246 is performed which will be described below. If pruning is not required [242:NO], then none of the enhancement layers are pruned from the first SVC encoded video stream. As such, method 200 continues with step 246. In step 246, the first SVC encoded video stream is transferred from the second MANE to a next network node (e.g., SVC decoder 118 of FIG. 1) in the communications path between the video source and the respective intended destination device (e.g., destination device 124 of FIG. 1). At the next network node, the first SVC encoded video stream is decoded and forwarded to the respective intended destination device, as shown by step 248. Subsequently, step 250 is performed where method 200 ends or other processing is performed.

Referring now to FIG. 2D, step 252 involves selecting one of a plurality of next network nodes (e.g., SVC decoders 126 and 130 of FIG. 1) which are downstream from and one-hop away from the second MANE. Next in step 254, the second MANE performs operations to determine a data transfer rate for the first SVC encoded video stream based on one-hop throughput conditions (i.e., the throughput conditions of a communications link between the second MANE and the next network node in a communications path from the video source to a respective intended destination device). Once the data transfer rate has been determined, a decision is made in step 256 as to whether or not the data transfer rate requires pruning of at least one enhancement layer from the first SVC encoded video stream.

If pruning is required [256:YES], then at least one enhancement layer is pruned from the first SVC encoded video stream as shown by step 258. In contrast, no pruning is performed when it is not required [256:NO]. Next in step 260, the first SVC encoded video stream is transferred from the second MANE to the next network node (e.g., SVC decoder 126 or 130 of FIG. 1) in the communications path between the video source and the respective intended destination device (e.g., destination device 128 or 130 of FIG. 1). At the next network node, the first SVC encoded video stream is decoded and forwarded to the respective intended destination device, as shown by step 262. Upon completing step 262, decisions step 264 is performed in which a decision is made as to whether or not the second MANE has performed operations for each of the plurality of next network nodes that are downstream and one-hop away therefrom. If not [264:NO], then method 200 returns to step 252. If so [264:YES], then step 266 is performed where method 200 ends or other operations are performed.

In view of the forgoing, the present disclosure concerns: a scalable video encoder that selects encoding parameters based on MANET conditions; and a source MANET MANE that selects one or more modulation formats for the scalable video stream components based on MANET conditions; a forwarding MANET MANE that selectively forwards scalable video stream components based on MANET conditions and that may or may not alter the modulation formats associated with each stream component; and source and forwarding MANET MANEs that are capable of recognizing scalable video stream components when they are encrypted. The MANET conditions can include, but are not limited to: a given node's set of one-hop link quality metrics to its immediate neighbor (e.g., instantaneous values and/or variance in time); all one-hop link quality metrics within a possible path of travel for the subject video stream (e.g., instantaneous values, variance in time, variance in space); and/or the existing traffic being carried by the MANET and its relative priority in relation to the subject video stream. The link metrics include, but are not limited to, SNR, channel impulse response delay spread, Doppler spread and MIMO channel metrics.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for controlling video stream distribution in an ad hoc network, comprising:
receiving, by a first network node, a first video stream having a Scalable Video Codec (“SVC”) format and a first data transfer rate, the first network node residing between a video source device and a video destination device;
determining, by the first network node, a second data transfer rate for the first video stream based on one-hop throughput conditions of a communications link between the first network node and a second network node downstream and one-hop away from the first network node; and
transferring the first video stream from the first network node to the second network node at the second data transfer rate which was previously determined, whereby any link quality impediments within the ad hoc network are resolved locally at the first network node.

2. The method according to claim 1, wherein the second data transfer rate is different than the first data transfer rate.

3. The method according to claim 1, further comprising pruning at least one enhancement layer from the first video stream prior to said transferring when the second data transfer rate is lower than said first data transfer rate.

4. The method according to claim 1, further comprising selecting a total number of enhancement layers for the first video stream based on at least one of a congestion level of the ad hoc network, a current link quality, an estimate link quality as a function of time, and priority levels of at least two video streams.

5. The method according to claim 1, wherein the total number of enhancement layers is selected prior to any SVC encoding of the first video stream.

6. The method according to claim 1, wherein the total number of enhancement layers contained in the first video stream immediately after being SVC encoded is different than that of a second video stream immediately after being SVC encoded.

7. The method according to claim 1, further comprising modulating a base layer of the first video stream onto a carrier signal using a first modulation scheme that is different than a second modulation scheme used to modulate an enhancement layer of the first video stream onto the carrier signal.

8. The method according to claim 1, wherein the transferring is performed using different data transfer rates for at least a base layer and a first enhancement layer of the first video stream when a measured variance of a channel link quality or impulse response matrix over a given period of time reaches an undesirable level.

9. The method according to claim 1, wherein the transferring is performed using a single data transfer rate for at least a base layer and a first enhancement layer of the first video stream when a measured variance of a channel link quality or impulse response matrix over a given period of time is of a satisfactory level.

10. The method according to claim 1, further comprising pruning at least one enhancement layer from the first video stream based on a priority thereof and a priority of at least one other second video stream being transferred in the ad hoc network.

11. A system, comprising:
a first network node residing between a video source device and a video destination device, the first network node configured to
receive a first video stream having a Scalable Video Codec (“SVC”) format and a first data transfer rate,
determine a second data transfer rate for the first video stream based on one-hop throughput conditions of a communications link between the first network node and a second network node downstream and one-hop away from the first network node, and
transfer the first video stream from the first network node to the second network node at the second data transfer rate which was previously determined, whereby any link quality impediments within an ad hoc network are resolved locally at the first network node.

12. The system according to claim 11, wherein the second data transfer rate is different than the first data transfer rate.

13. The system according to claim 11, wherein the first network node is further configured to prune at least one enhancement layer from the first video stream prior to said transferring when the second data transfer rate is lower than said first data transfer rate.

14. The system according to claim 11, wherein a total number of enhancement layers for the first video stream is selected based on at least one of a congestion level of the ad hoc network, a current link quality, an estimate link quality as a function of time, and priority levels of at least two video streams.

15. The system according to claim 11, wherein the total number of enhancement layers is selected prior to any SVC encoding of the first video stream.

16. The system according to claim 11, wherein the total number of enhancement layers contained in the first video stream immediately after being SVC encoded is different than that of a second video stream immediately after being SVC encoded.

17. The system according to claim 11, wherein a base layer of the first video stream is modulated onto a carrier signal using a first modulation scheme that is different than a second modulation scheme used to modulate an enhancement layer of the first video stream onto the carrier signal.

18. The system according to claim 11, wherein different data transfer rates are used for transferring at least a base layer and a first enhancement layer of the first video stream through at least a portion of the ad hoc network when a measured variance of a channel link quality or impulse response matrix over a given period of time reaches an undesirable level.

19. The system according to claim 11, wherein a single data transfer rate is used for transferring at least a base layer and a first enhancement layer of the first video stream through the ad hoc network when a measured variance of a channel link quality or impulse response matrix over a given period of time is of a satisfactory level.

20. The system according to claim 11, wherein the first network node is further configured to prune at least one enhancement layer from the first video stream based on a priority thereof and a priority of at least one other second video stream being transferred in the ad hoc network.
